(19) United States
(12) Patent Application Publication
(10) Pub. No.: US 2009/0053372 A1
(43) Pub. Date: Feb. 26, 2009

(54) RESEALABLE FOOD BAGS AND METHOD THEREOF

(76) Inventors: Samuel Hambrick, Levittown, PA (US); Janice Vanselow, Marlborough, MA (US)

Correspondence Address: BARNES & THORNBURG LLP, 11 SOUTH MERIDIAN, INDIANAPOLIS, IN, 46204, US

(21) Appl. No.: 11/844,181

(22) Filed: Aug. 23, 2007

(51) Int. Cl. B65D 85/00; B05D 5/10; B32B 7/12

(52) U.S. Cl. 426/125; 427/207.1; 427/208.2; 428/41.8

(57) ABSTRACT

Embodiments of the present invention generally relate to resealable food bags utilizing an adhesive compound, and a method thereof. In one embodiment of the present invention, a resealable food stuff bag comprises a food stuff bag with an interior and an exterior, and an adhesive tape applied to the interior of the food bag, wherein the adhesive tape comprises a carrier with a first side and a second side, a layer of food-grade permanent adhesive applied to the first side of the carrier, and a layer of food-grade removable adhesive applied to the second side of the carrier.

### BACKGROUND

1. Field of the Invention

Embodiments of the present invention generally relate to resealable food bags, and more specifically, to a food bag with a resealable food-grade adhesive compound wherein the bag may be substantially resealed.

2. Description of the Related Art

Food bags, such as potato chip bags, have been in existence for many years. Attempts have been made to create food bags capable of resealing and reopening several times, thus preserving the quality of the product contained inside. However, due to the highly-regulated food industry, the use of certain adhesives as a means for resealing a food bag has been largely unsuccessful. Specifically, the United States Food and Drug Administration (“FDA”) closely regulates any food product being sold in commerce, including the utensils, packaging, etc., associated therewith. For example, Title 21 of the Code of Federal Regulations (“CFR”), section 175 et seq., is directed to the use of adhesives and adhesive components allowable for contact with food products in the U.S.

Aside from the strict regulations, other problems arise with known methods of using adhesives as a means for resealing a food bag. Most food bags are initially sealed by the manufacturer using a heat-seal coating process. In many instances, an adhesive resealing means would melt into the food product due to the high heat process of heat-sealing.

Thus, there is a need for a resealable food bag utilizing a resealable food-grade adhesive compound.

### SUMMARY OF THE INVENTION

Embodiments of the present invention generally relate to resealable food bags utilizing an adhesive compound, and a method thereof. In one embodiment of the present invention, an adhesive tape comprises a carrier with a first side and a second side, a layer of food-grade permanent adhesive applied to the first side of the carrier, and a layer of food-grade removable adhesive applied to the second side of the carrier.

In another embodiment, a method of forming an adhesive tape comprises providing a carrier, applying a layer of food-grade permanent adhesive to a first side of the carrier, and applying the layer of food-grade removable adhesive to the second side of the carrier.

In yet another embodiment of the present invention, a resealable food stuff bag comprises a food stuff bag with an interior and an exterior, and an adhesive tape applied to the interior of the food bag, wherein the adhesive tape comprises a carrier with a first side and a second side, a layer of food-grade permanent adhesive applied to the first side of the carrier, and a layer of food-grade removable adhesive applied to the second side of the carrier.

### BRIEF DESCRIPTION OF THE DRAWING

So the manner in which the above recited features of the present invention can be understood in detail, a more particular description of embodiments of the present invention, briefly summarized above, may be had by reference to embodiments, one of which is illustrated in the appended drawing. It is to be noted, however, the appended drawing illustrates only a typical embodiment of embodiments encompassed within the scope of the present invention, and, therefore, is not to be considered limiting, for the present invention may admit to other equally effective embodiments.

FIG. 1 depicts an adhesive tape in accordance with one embodiment of the present invention; and

FIG. 2 depicts a flowchart of a method in accordance with one embodiment of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figure.

### DETAILED DESCRIPTION

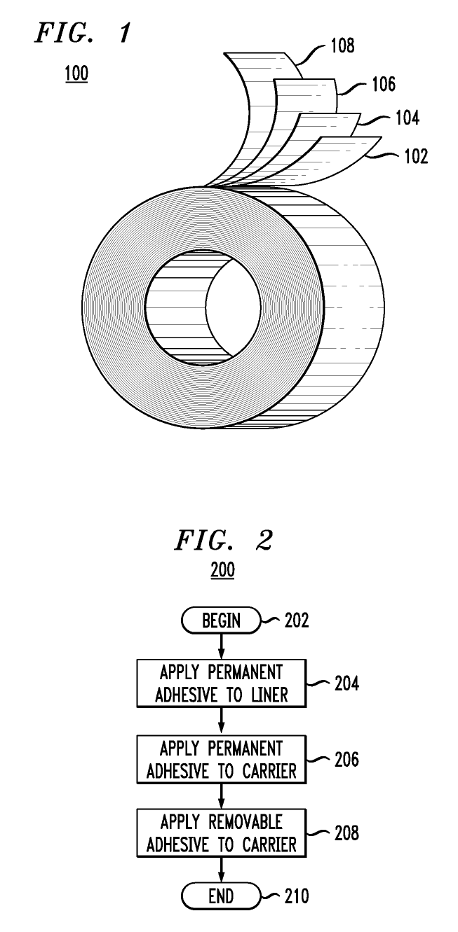

FIG. 1 depicts one embodiment of an adhesive tape for use with resealable food bags in accordance with the present invention. In one embodiment, the adhesive tape 100 comprises a removable adhesive 102 disposed on one side of a carrier 104 layer. A permanent adhesive 106 is disposed on the other side of the carrier 104. Optionally, a release liner 108 is provided on the permanent adhesive 106.

The carrier 104 may be any carrier suitable for embodiments of the present invention. Generally, the carrier 104 comprises a polymer. In one embodiment, the carrier 104 comprises polyethylene terephthalate (PET). Alternatively, in additional embodiments, the carrier 104 may comprise at least one of polyethylene (PE), polypropylene (PP), polysulfone (UDEL), polyethersulphone (PES), polyetherimide (ULTEM), or the like.

The carrier 104 may be any thickness suitable for embodiments of the present invention. In one embodiment, the carrier 104 is between about 0.10 mils to about 2 mils in thickness. In one embodiment, the carrier 104 is about 0.5 mils thick. The carrier 104 may be any width suitable for embodiments of the present invention. In one embodiment, the width of the carrier 104 is between about 0.25 inch and about 4 inches. In another embodiment, the width of the carrier 104 is between about 0.5 inch and about 2 inches. In one embodiment, the carrier 104 is between about 0.375 inch and about 1.25 inches wide.

In some embodiments, one or both sides of the carrier 104 may be treated to increase the surface tension of the carrier 104. In one embodiment, both sides of the carrier 104 are corona treated. The corona treatment may be performed on conventional corona treating equipment at a density of about 4.0 to 8.5, having kilowatts relative to speed, and at a line speed in the range of from about 30 to about 70 feet per minute. In one embodiment, the carrier 104 may be corona treated at a density level of about 8.5 and at a line speed of between about 30 feet per minute to about 120 feet per minute.

The removable adhesive 102 may be any adhesive suitable for embodiments of the present invention. Generally, the removable adhesive 102 comprises a food-grade adhesive complying with the FDA requirements set forth in 21 CFR §175 et seq. In one embodiment, the removable adhesive 102 is a pressure sensitive adhesive. In another embodiment, the removable adhesive 102 comprises an acrylic polymer adhesive. One exemplary acrylic adhesive is AROSET 284, commercially available from Ashland Specialty Chemical Company of Totowa, N.J. In another embodiment, the removable adhesive 102 comprises an acrylic adhesive and between about 0% to about 15% of aliphatic resin. In one embodiment, the removable adhesive 102 comprises about 2.5% of aliphatic resin. One exemplary aliphatic resin is WINGTACK-95, commercially available from Sartomer Company, Inc. of Exton, Pa.

In some embodiments, the removable adhesive 102 further comprises between about 0% to about 15% of a rosin ester tackifying resin. In one embodiment, the removable adhesive 102 comprises about 2.5% rosin ester tackifying resin or other chemical compound for improving heat stability. One exemplary tackifying resin is SYLVATAC RE 85, commercially available from Arizona Chemical, Inc. of Jacksonville, Fla. In other embodiments, the removable adhesive 102 may comprise other substances, such as those described in 21 CFR §175.105, or the like.

The permanent adhesive 106 may be any adhesive suitable for embodiments of the present invention. Generally, the permanent adhesive 106 comprises a food-grade adhesive complying with the FDA requirements set forth in 21 CFR §175 et seq. In one embodiment, the permanent adhesive 106 comprises an acrylic or rubber adhesive. In another embodiment, the permanent adhesive 106 is a pressure sensitive adhesive. One exemplary permanent adhesive 106 is MORSTIK 116A, commercially available from Rohm & Hass of Philadelphia, Pa. In other embodiments, the permanent adhesive may comprise other substances, such as those discussed above with respect to the removable adhesive, those described in 21 CFR §175.105, or the like.

The optional release liner 108 may be any liner suitable for embodiments of the present invention. In one embodiment, the liner 108 comprises a polymeric film, such as polyethylene, polyester, and the like. In another embodiment, the liner 108 comprises paper, fiberboard, or other cellulosic materials.

FIG. 2 depicts a flowchart of a method of making adhesive tape in accordance with one embodiment of the present invention, and will be discussed with reference to the embodiment of the adhesive tape FIG. 1. The method 200 begins at step 202. At step 204, a permanent adhesive 106 is applied to a first side of a liner 108. In one embodiment, the permanent adhesive 106 is applied at between about 16 pounds per ream and 40 pounds per ream. In another embodiment, the permanent adhesive 106 is applied to the release liner 108 at about 27 pounds per ream. Once applied, the permanent adhesive 106 and liner 108 are dried in an oven having a temperature of between about 150 and 300 degrees Fahrenheit. In one embodiment, the permanent adhesive 106 and liner 108 are dried in an oven having a temperature of about 190 degrees Fahrenheit for approximately two minutes.

At step 206, the permanent adhesive 106 is applied to a first side of a carrier layer 104. In some embodiments, the carrier 104 is corona treated on one or both sides. In one embodiment, a second side of the carrier 104 is corona treated after the permanent adhesive 106 is applied to the first side. When applied, the carrier is generally heat laminated such that the permanent adhesive is adhered substantially to the carrier. At step 208, a removable adhesive 102 is applied to the second side of the carrier 104 at between about 16 pounds per ream and 40 pounds per ream. In another embodiment, the removable adhesive 102 is applied to the carrier 104 at about 27 pounds per ream. Once applied, the removable adhesive 102 and carrier 104 are dried in an oven at a temperature of between about 150 and 300 degrees Fahrenheit. In one embodiment, the removable adhesive 102 and carrier 104 are dried in an oven at a temperature of about 225 degrees Fahrenheit, for approximately two minutes. The method 200 ends at step 210.

The adhesive tape 100 can be utilized during the manufacturing of a resealable food bag (i.e., a bag designed to store a food product for commercial, retail, or personal markets) (not shown). A resealable food bag, e.g., a potato chip bag, has an interior layer and exterior layer, and is sealed on three sides, using known methods in the industry, resulting in a food bag having an open top edge, capable of storing a food product. The exterior layer generally comprises a polymer, such as polypropylene, or the like. The interior layer generally comprises a polymer, such as polypropylene or the like. In some embodiments, the interior layer may be metallized by an FDA approved material, such as aluminum, or the like.

The adhesive tape 100 is secured via the removable adhesive 102 on the interior layer of the food bag, along the top edge. The food bag is sealed using heat-sealing, or other FDA approved sealing methods. At some point in time (e.g., after purchase at a grocery store, etc.), the heat-seal is open, typically by cutting or tearing the interior and exterior layers of the food bag. In one embodiment, where no release liner 108 is provided, the food bag may be resealed by exerting a compressive force on the exterior layer of the food bag, near the adhesive tape 100. In such an embodiment, the permanent adhesive 106 adheres to an opposing side of the interior layer of the food bag, causing a temporary substantially air-tight seal. In another embodiment, where a release liner is provided, the liner should be removed prior to applying a compressive force on the exterior layer, near the adhesive tape 100.

To re-open the food bag, a tensile force is applied to the exterior layer of the food bag, overcoming the adhesion strength of the removable adhesive 102. In many embodiments of the present invention, the food bag may be resealed at least one time. In other embodiments, the food bag may be resealed and re-opened at least a plurality of times. In one embodiment, the food bag may be resealed at least two times.

Combinations of individual embodiments described herein are contemplated by additional embodiments of the present invention. While the foregoing is directed to embodiments of the present invention, other and further embodiments of the invention may be devised without departing from the basic scope thereof, and the scope thereof is determined by the claims that follow.

What is claimed is:

1. An adhesive tape, comprising:
a carrier with a first side and a second side;
a layer of food-grade permanent adhesive applied to the first side of the carrier; and
a layer of food-grade removable adhesive applied to the second side of the carrier.

2. The adhesive tape of claim 1, wherein the adhesive tape has a width of at least one quarter of an inch.

3. The adhesive tape of claim 1, wherein the carrier has a thickness of about 0.5 mils.

4. The adhesive tape of claim 1, wherein the carrier comprises at least one of polyester, polyethylene, polyethylene-terephthalate, polypropylene, polyvinylidine chloride, polyvinylchloride, or polyolefin.

5. The adhesive tape of claim 1, wherein the food-grade permanent adhesive comprises at least a rubber or an acrylic food-grade adhesive compound.

6. The adhesive tape of claim 1, wherein the food-grade removable adhesive comprises a food-grade pressure sensitive adhesive compound.

7. The adhesive tape of claim 1, wherein the food-grade removable adhesive comprises a food-grade acrylic based adhesive compound.

8. The adhesive tape of claim 1, wherein the food-grade removable adhesive further comprises a tackifying resin.

9. The adhesive tape of claim 8, wherein the food-grade removable adhesive further comprises about 0.0 percent to about 15.0 percent by weight of the tackifying resin.

10. The adhesive tape of claim 8, wherein the food-grade removable adhesive further comprises about 2.5 percent by weight of the tackifying resin.

11. The adhesive tape of claim 8, wherein the tackifying resin is an aliphatic resin.

12. The adhesive tape of claim 8, wherein the tackifying resin is a rosin ester resin

13. The adhesive tape of claim 1, further comprising a release liner applied to an exposed side of the layer of food-grade permanent adhesive compound.

14. The adhesive tape of claim 13, wherein the release liner comprises at least one of polymeric film liners, paper liners, or board liners.

15. A method of forming an adhesive tape comprising:
providing a carrier;
applying a layer of food-grade permanent adhesive to a first side of the carrier; and
applying the layer of food-grade removable adhesive to the second side of the carrier.

16. The method of claim 15, further comprising applying the layer of food-grade permanent adhesive by coating the first side the carrier between about 16 pounds and about 40 pounds per ream.

17. The method of claim 16, further comprising applying the layer of food-grade permanent adhesive by coating the first side the carrier at about 27 pounds per ream.

18. The method of claim 15, further comprising applying the layer of food-grade removable adhesive by coating the second side the carrier between about 16 pounds and about 40 pounds per ream.

19. The method of claim 18, further comprising applying the layer of food-grade removable adhesive by coating the second side the carrier at about 27 pounds per ream.

20. The method of claim 15, further comprising processing the carrier such that the layer of food-grade removable adhesive compound is adhered by heat lamination to the carrier.

21. The method of claim 15, further comprising corona treating at least a side of the carrier.

22. The method of claim 15, further comprising drying the layer of food-grade removable adhesive at a temperature of about 225 degrees Fahrenheit.

23. The method of claim 22, further comprising drying the layer of food-grade removable adhesive for a time period of about two minutes.

24. The method of claim 15, further comprising:
applying the layer of food-grade permanent adhesive to a first side of a release liner material; and
drying the layer of food-grade permanent adhesive prior to applying the layer of food-grade permanent adhesive to the first side of the carrier.

25. The adhesive tape of claim 24, further comprising applying the layer of food-grade permanent adhesive by coating the first side of the release liner material at about 27 pounds per ream.

26. The adhesive tape of claim 24, further comprising drying the layer of food-grade permanent adhesive at a temperature of about 190 degrees Fahrenheit.

27. The adhesive tape of claim 26, further comprising drying the layer of food-grade permanent adhesive for a time period of about two minutes.

28. A resealable food bag comprising:
a food stuff bag with an interior layer and an exterior layer; and
an adhesive tape applied to the interior layer of the food bag, wherein the adhesive tape comprises:
a carrier with a first side and a second side;
a layer of food-grade permanent adhesive applied to the first side of the carrier; and
a layer of food-grade removable adhesive applied to the second side of the carrier.

29. The resealable food bag of claim 28, wherein the interior layer of the food bag comprises polypropylene.

30. The resealable food bag of claim 29, wherein the interior layer is at least partially metallized.
